(19) United States
(12) Patent Application Publication
(10) Pub. No.: US 2013/0171602 A1
(43) Pub. Date: Jul. 4, 2013

(54) TABLEWARE PRACTICE TOOL KIT

(71) Applicant: Tseng-Min Lin, Taipei City (TW)

(72) Inventor: Tseng-Min Lin, Taipei City (TW)

(21) Appl. No.: 13/718,684

(22) Filed: Dec. 18, 2012

(30) Foreign Application Priority Data
Dec. 28, 2011 (TW) 100149047

(51) Int. Cl. G09B 19/00

(52) U.S. Cl. CPC G09B 19/00
USPC 434/260

(57) ABSTRACT

A tableware practice tool kit includes a combined main body formed by combining a plurality of components in an assembling way and/or in a way of stacking blocks, and forming a space for accommodating tableware. The tableware practice tool kit provides tableware and objects that are similar to shapes of different kinds of food and is convenient to carry. Therefore, the practice is not limited by the time and environment, and a person can practice using the tableware at any time in a game manner so that the person can use the tableware well rapidly.

### BACKGROUND

1. Technical Field

The present invention relates to the field of tableware, and in particular, to a tableware practice tool kit.

2. Related Art

Using tableware is a familiar work with ease for people who have long used the tableware. However, it is not easy for infants or people who never or seldom use the tableware (such as chopsticks) to take food (such as beans, pancakes, noodles, greens, rice, eggs, sliced meat, or spring rolls in different shapes). Therefore, it needs a long time to practice using tableware before one can use the tableware to take food skillfully.

For example, to practice using the chopsticks, a person usually has to practice using the chopsticks during the dining time so as to be familiar with the handle, direction, angle and force of the chopsticks when the food is taken. However, there is an obvious problem that the practicing time is not enough when the use of chopsticks is practiced only during the dining time, and the person cannot practice using the chopsticks again until the next dining time. Therefore, the practice is a relatively slow learning process for being familiar with the use of chopsticks.

Furthermore, the chopsticks and different kinds of food are not always available in all environments. For example, a person cannot practice using the chopsticks when having dinner outdoors.

### SUMMARY

In view of the above problems, the objective of the present invention is to provide a tableware practice tool kit, which provides tableware and objects that are similar to shapes of different kinds of food and is convenient to carry. Therefore, the practice is not limited by time and environment, and a person can practice using the tableware at any time in a game manner so that the person can use the tableware well rapidly.

A first embodiment of the present invention is a tableware practice tool kit, including a combined main body formed by combining a plurality of components in an assembling way and/or in a way of stacking blocks, and forming a space for accommodating tableware.

A second embodiment of the present invention is another tableware practice tool kit, including a bag main body having an internal storage space, and a covering part disposed on the outside surface of the bag main body, where the covering part is covered over the outside surface of the bag main body so as to form a space for accommodating tableware.

### BRIEF DESCRIPTION OF THE DRAWINGS

FIG. 1A is a three-dimensional view of a tableware practice tool kit according to a first embodiment of the present invention;

FIG. 1B is a cross-sectional view of the tableware practice tool kit in FIG. 1A along line I-I;

FIG. 1C is a top view of the tableware practice tool kit according to the first embodiment of the present invention;

FIG. 1D is a three-dimensional view of a part of components of the tableware practice tool kit according to the first embodiment of the present invention;

FIG. 1E is a three-dimensional view of a part of components of the tableware practice tool kit according to the first embodiment of the present invention;

FIG. 2 is a three-dimensional view of a tableware practice tool kit according to a second embodiment of the present invention;

FIG. 3 is a schematic outside view of a tableware practice tool kit according to a third embodiment of the present invention;

FIG. 4A is a side view of a combined main body into which a chopstick of a tableware practice tool kit is inserted according to a fourth embodiment of the present invention;

FIG. 4B is a side view of a combined main body into which a chopstick of a tableware practice tool kit is screwed according to the fourth embodiment of the present invention;

FIG. 5A is a three-dimensional view of a tableware practice tool kit according to a fifth embodiment of the present invention;

FIG. 5B is a top view of the tableware practice tool kit according to the fifth embodiment of the present invention;

FIG. 6A is a three-dimensional view of a tableware practice tool kit according to a sixth embodiment of the present invention;

FIG. 6B is a top view of the tableware practice tool kit according to the sixth embodiment of the present invention;

FIG. 7A is a three-dimensional view of a tableware practice tool kit according to a seventh embodiment of the present invention;

FIG. 7B is a top view of the tableware practice tool kit according to the seventh embodiment of the present invention;

FIG. 8A is a three-dimensional view of a tableware practice tool kit according to an eighth embodiment of the present invention;

FIG. 8B is a top view of the tableware practice tool kit according to the eighth embodiment of the present invention;

FIG. 9A is a side view of a tableware practice tool kit according to a ninth embodiment of to the present invention;

FIG. 9B is a top view of the tableware practice tool kit in FIG. 9A along line IX-IX;

FIG. 9C is a cross-sectional view of the tableware practice tool kit according to the ninth embodiment of the present invention;

FIG. 10A is a three-dimensional view of a tableware practice tool kit according to a tenth embodiment of the present invention;

FIG. 10B is a top view of the tableware practice tool kit according to the tenth embodiment of the present invention;

FIG. 11 is a cross-sectional view of a tableware practice tool kit according to an eleventh embodiment of the present invention;

FIG. 12 is an exploded view of a tableware practice tool kit according to a twelfth embodiment of the present invention;

FIG. 13A is a three-dimensional view of a tableware practice tool kit according to a thirteenth embodiment of the present invention;

FIG. 13B is a partial three-dimensional view of the tableware practice tool kit according to the thirteenth embodiment of the present invention;

FIG. 13C is a cross-sectional view of the tableware practice tool kit in FIG. 13A along line XIII-XIII;

FIG. 14 is an exploded three-dimensional view of a tableware practice tool kit according to a fourteenth embodiment of the present invention;

FIG. 15 is an exploded three-dimensional view of a tableware practice tool kit according to a fifteenth embodiment of the present invention;

FIG. 16 is an exploded three-dimensional view of a tableware practice tool kit according to a sixteenth embodiment of the present invention;

FIG. 17A is an exploded view of a tableware practice tool kit according to a seventeenth embodiment of the present invention;

FIG. 17B is an assembly view of the tableware practice tool kit according to the seventeenth embodiment of the present invention;

FIG. 17C is another assembly view of the tableware practice tool kit according to the seventeenth embodiment of the present invention;

FIG. 18A is a three-dimensional view of a tableware practice tool kit according to an eighteenth embodiment of the present invention; and

FIG. 18B is another three-dimensional view of the tableware practice tool kit according to the eighteenth embodiment of the present invention.

### DETAILED DESCRIPTION

To make persons of ordinary skill in the art further understand the present invention, several preferred embodiments of the present invention are described in the following with reference to the accompanying drawings to illustrate the structure of and the efficacy to be achieved by the present invention in details.

A tableware practice tool kit of the present invention includes tableware, a combined main body, and objects for practice. The combined main body is formed by combining a plurality of components having geometric shapes in an assembling way and/or in a way of stacking blocks, and forms a space for accommodating the tableware.

The tableware is one of or a combination of chopsticks, a spoon, a knife, and a fork. The objects for practice have a shape of one of a bean, a round ball, a pancake, and noodle or have shapes of a combination thereof. The material of the tableware, combined main body and objects for practice are one of cloth, glass, wood, paper, plastic, rubber, foam, metal, soil, and clay, or a composite material thereof.

Several embodiments are given below to describe the structures and applications of the tableware practice tool kit of the present invention, where the chopsticks serve as the tableware in the application of the embodiments. However, this is not to limit the application of the present invention, and any tableware can be applied in the tableware practice tool kit of the present invention.

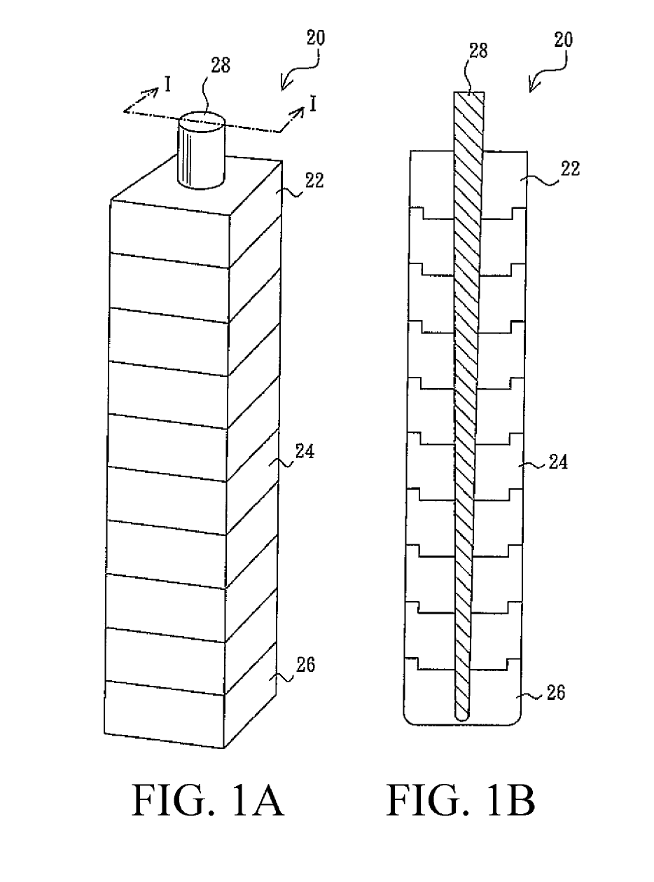

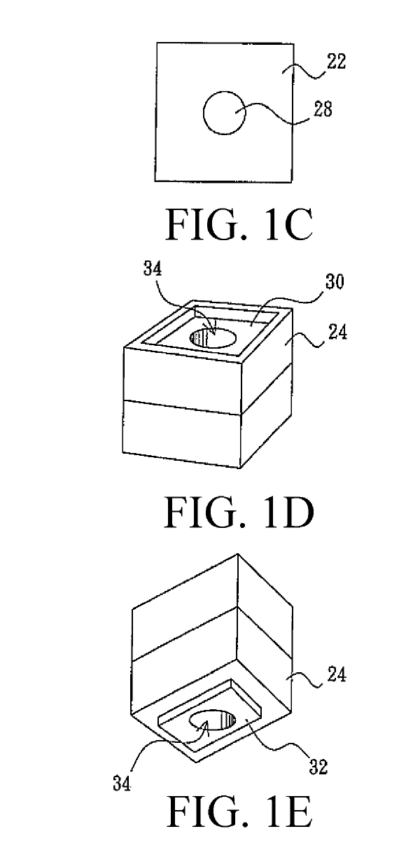

FIGS. 1A to 1C are respectively a three-dimensional view, a cross-sectional view and a top view of a tableware practice tool kit according to a first embodiment of the present invention. FIGS. 1D and 1E are respectively three-dimensional views of a part of components of the tableware practice tool kit according to the first embodiment of the present invention.

In FIGS. 1A to 1E, the tableware practice tool kit 20 is formed by an upper component 22, a plurality of middle components 24, a lower component 26, and a chopstick 28. A square groove 30 is formed on a combined face of each middle component 24 having a square body, and a square flange 32 is formed on the other combined face. The square flange 32 of a middle component 24 is engaged in the square groove 30 of another middle component 24 in a way of stacking blocks. However, the groove and flange can have any geometric shape, which is not limited to the square shape.

The square flange 32 is formed on only one combined face of the upper component 22 having a square body, and is engaged in the square groove 30 of the middle component 24 in a way of stacking blocks. A square groove 30 is formed on only one combined face of the lower component 26 having a square body; and the square flange 32 of the middle component 24 is engaged in the square groove 30 of the lower component 26 in a way of stacking blocks.

The upper component 22, middle components 24 and lower component 26 are combined into the combined main body in a way of stacking blocks. Each of the upper component 22, middle components 24 and lower component 26 has a round hole 34 (which is not limited to a round hole, and a hole in any geometric shape is applicable) to connect the components vertically. Thus, a space of the combined main body into which the chopstick 28 is inserted is formed.

In the first embodiment, the upper component 22, middle components 24, and lower component 26 are combined into a combined main body in a way of stacking blocks for practicing combining and disassembling. The chopstick 28 is inserted into and taken out from the round hole 34 of the combined main body. In this way, the handle, direction, angle, and force of hands are trained.

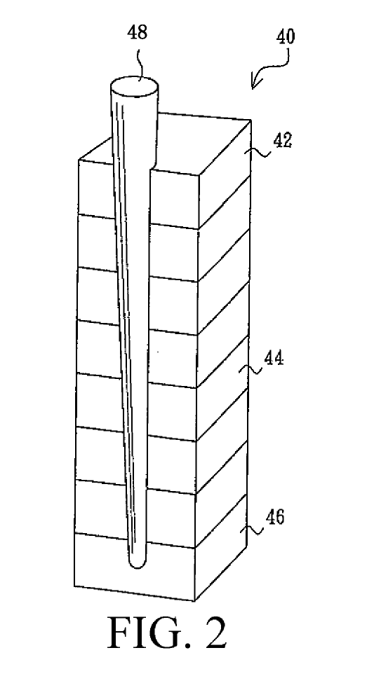

FIG. 2 is a three-dimensional view of a tableware practice tool kit according to a second embodiment of the present invention. In FIG. 2, the tableware practice tool kit 40 is formed by an upper component 42, a plurality of middle components 44, a lower component 46, and a chopstick 48.

In the second embodiment, the way that the upper component 42, middle components 44 and lower component 46 are combined into the combined main body is similar to that in the first embodiment, but the difference between the two is that: the space for accommodating the chopstick 48 in the combined main body is formed in a side of the combined main body in the second embodiment, so that a part of the surface of the chopstick 48 is exposed outside the combined main body when the chopstick 48 is inserted into the space of the combined main body.

For make the description concise, the same or similar structure and efficacy of the second and first embodiments are not elaborated herein.

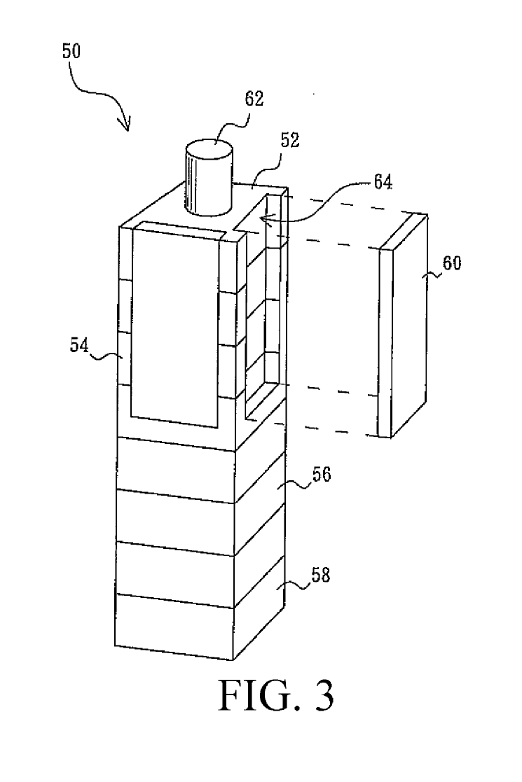

FIG. 3 is an outside view of a tableware practice tool kit according to a third embodiment of the present invention. In FIG. 3, the tableware practice tool kit 50 is formed by an upper component 52, a plurality of middle components 54 and 56, a side component 60, a lower component 58, and a chopstick 62.

In the third embodiment, the way that upper component 25, middle components 54 and 56, and lower component 58 are combined into the combined main body is similar to that in the first embodiment, but the difference between the two is that: a square groove 64 is formed on a side of the upper component 52 and the middle components 54 of the combined main body in the third embodiment, and the square side component 60 is engaged in the square groove 64 of the upper component 52 and the middle components 54 so as to form the cubic combined main body.

For make the description concise, the same or similar structure and efficacy of the third and first embodiments are not elaborated herein.

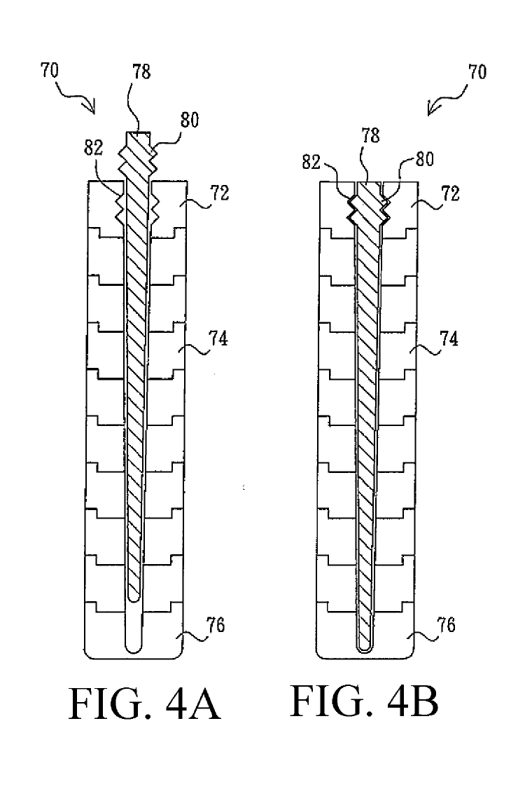

FIGS. 4A and 4B are respectively side views of a combined main body into which a chopstick of a tableware practice tool kit is inserted and a combined main body into which a chopstick is screwed according to a fourth embodiment of the present invention. In FIGS. 4A and 4B, the tableware practice tool kit 70 is formed by an upper component 72, a plurality of middle components 74, a lower component 76, and a chopstick 78.

In the fourth embodiment, the way that the upper component 72, middle components 74, and lower component 76 are combined into the combined main body is similar to that in the first embodiment, but the difference between the two is that: in the fourth embodiment, an end of the chopstick 18 as the tableware has an external thread 80, and the inner wall of the space in the upper component 72 for accommodating the chopstick 78 of the combined main body has an internal thread 82. Firstly, the chopstick 78 is inserted into the space in the combined main body for accommodating the chopstick 78; then the external thread in the chopstick 78 is screwed into the internal thread 82 in the inner wall of the upper component 72 so as to form the tableware practice tool kit 70. Further, the external thread 80 in the chopstick 78 is unscrewed from the inside thread 82 in the inner wall of the upper component 72 so as to take the chopstick 78 for practicing.

In the fourth embodiment, the combined main body that is combined in the way of stacking blocks is used for practicing combining and disassembling. The chopstick 78 is inserted into and taken out from the space in the combined main body, and the chopstick 78 is screwed into and unscrewed from the space in the combined main body. In this way, the handle, direction, angle, and force of hands are trained.

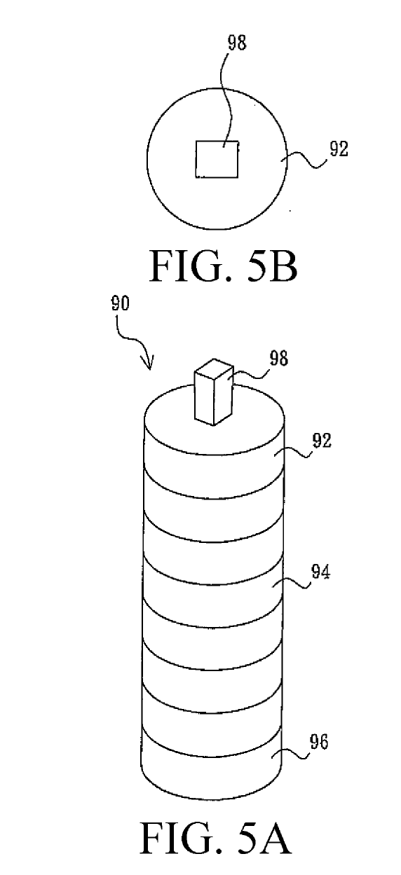

FIGS. 5A and 5B are respectively a three-dimensional view and a top view of a tableware practice tool kit according to a fifth embodiment of the present invention. In FIGS. 5A and 5B, the tableware practice tool kit 90 is formed by an upper component 92, a plurality of middle components 94, a lower component 96, and a chopstick 98.

In the fifth embodiment, the way that the upper component 92, middle components 94, and lower component 96 are combined into the combined main body is similar to that in the first embodiment, but the difference between the two is that: the upper component 92, middle components 94, and lower component 96 are all cylinders and are combined into a cylindrical combined main body; and each of the upper component 92, middle components 94, and lower component 96 has a square hole to connect the components vertically. Thus, a space of the combined main body into which the square chopstick 98 is inserted is formed.

For make the description concise, the same or similar structure and efficacy of the fifth and first embodiments are not elaborated herein.

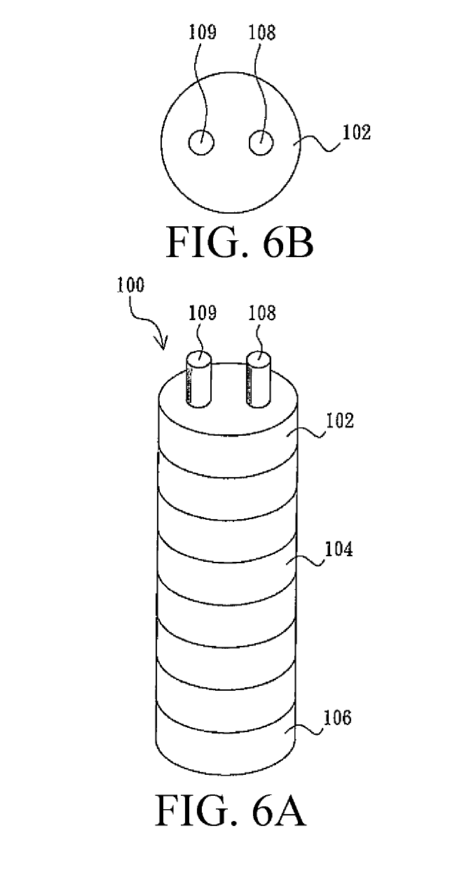

FIGS. 6A and 6B are respectively a three-dimensional view and a top view of a tableware practice tool kit according to a sixth embodiment of the present invention. In FIGS. 6A and 6B, the tableware practice tool kit 100 is formed by an upper component 102, a plurality of middle components 104, a lower component 106, and two chopsticks 108 and 109.

In the sixth embodiment, the way that the upper component 102, middle components 104, and lower component 106 are combined into the combined main body is similar to that in the fifth embodiment, but the difference between the two is that: each of the upper component 102, middle components 104, and lower component 106 has two holes to connect the connect the components vertically. Thus, two spaces in the combined main body into which the chopsticks 108 and 109 are inserted respectively are formed.

For make the description concise, the same or similar structure and efficacy of the sixth and fifth embodiments are not elaborated herein.

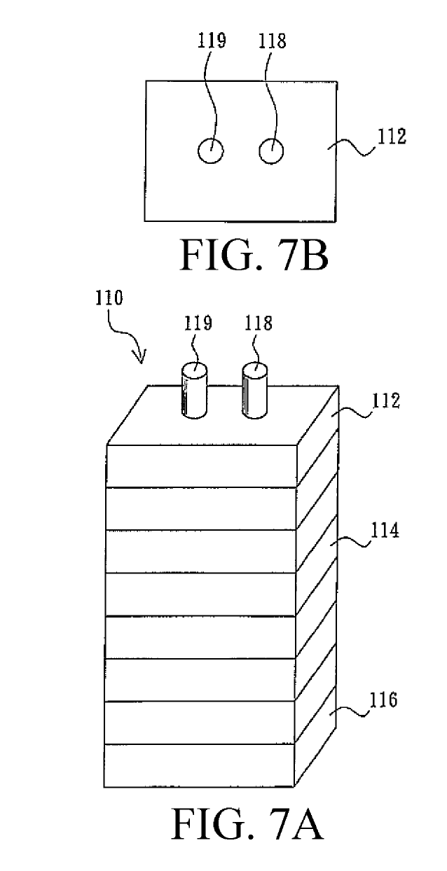

FIGS. 7A and 7B are respectively a three-dimensional view and a top view of a tableware practice tool kit according to a seventh embodiment of the present invention. In FIGS. 7A and 7B, the tableware practice tool kit 110 is formed by an upper component 112, a plurality of middle components 114, a lower component 116, and two chopsticks 118 and 119.

In the seventh embodiment, the way that the upper component 112, middle components 114, and lower component 116 are combined into the combined main body is similar to that in the sixth embodiment, but the difference between the two is that: the upper component 112, middle components 114, and lower component 116 are all cubes, and are combined into a cuboidal combined main body.

For make the description concise, the same or similar structure and efficacy of the seventh and sixth embodiments are not elaborated herein.

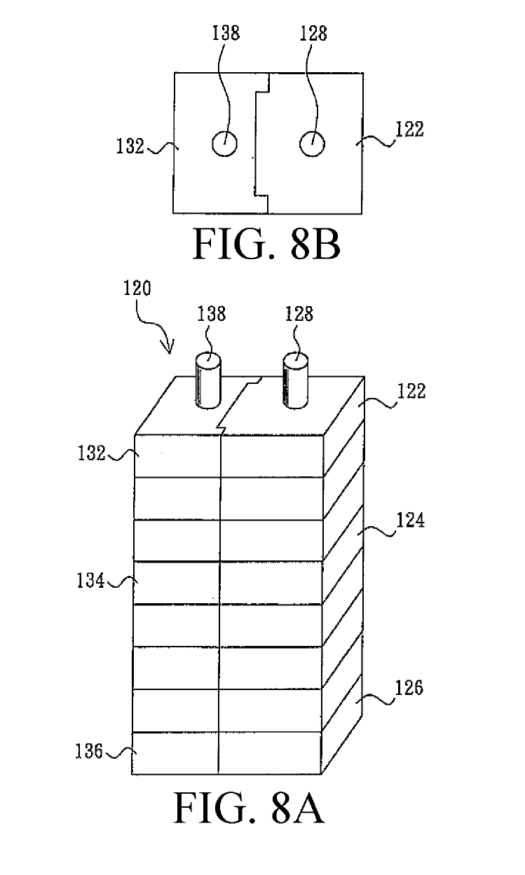

FIGS. 8A and 8B are respectively a three-dimensional view and a top view of a tableware practice tool kit according to an eighth embodiment of the present invention. In FIGS. 8A and 8B, the tableware practice tool kit 120 is formed by a first upper component 122, a plurality of first middle components 124, a first lower component 126, a first chopstick 128, a second upper component 132, a plurality of second middle components 134, a second lower component 136, and a second chopstick 138.

The difference between the eighth embodiment and the first embodiment is that: in the eighth embodiment, the first upper component 122, first middle components 124, and first lower component 126 are combined into a first combined main body, while the second upper component 132, second middle components 134, and second lower component 136 are combined into a second combined main body. A flange is formed on a combined face of the first combined main body, and a groove is formed in a combined face of the second combined main body. The flange of the first combined main body is engaged in the groove of the second combined main body. The first chopstick 128 and the second chopstick 129 are respectively inserted into the spaces for accommodating chopsticks in the first combined main body and the second combined main body so as to form the tableware practice tool kit 120 according to the eighth embodiment.

For make the description concise, the same or similar structure and efficacy of the eighth and first embodiments are not elaborated herein.

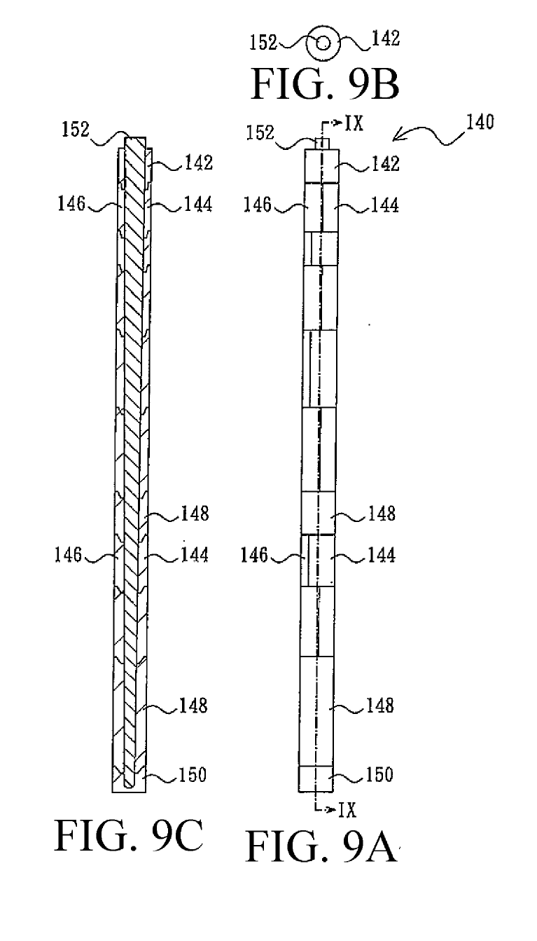

FIGS. 9A to 9C are respectively a three-dimensional view, a top view, and a cross-sectional view of a tableware practice tool kit according to a ninth embodiment of the present invention. In FIGS. 9A to 9C, the tableware practice tool kit 140 is formed by an upper component 142, a plurality of middle right components 144, a plurality of middle left components 146, a plurality of middle annular components 148, a lower component 150, and a chopstick 152.

The difference between the ninth embodiment and the first embodiment is in that: in the ninth embodiment, the middle right components 144 and middle left components 146 may be combined into a middle component having an annular shape, and the middle component having an annular shape may be combined with the upper component 142, other middle components having an annular shape, the middle annular components 148 or the lower component 150. The middle annular components 148 may be combined with the upper component 142, other middle annular components 148, or the lower component 150. Through the arrangement and combination of the upper component 142, middle right components 144, middle left components 146, middle annular components 148, and lower component 150, a combined main body having a long cylindrical shape is formed. Then, the chopstick 152 is inserted into the space for accommodating the chopstick 152 in the combined main body so as to form the tableware practice tool kit 140 according to the ninth embodiment.

For make the description concise, the same or similar structure and efficacy of the ninth and first embodiments are not elaborated herein.

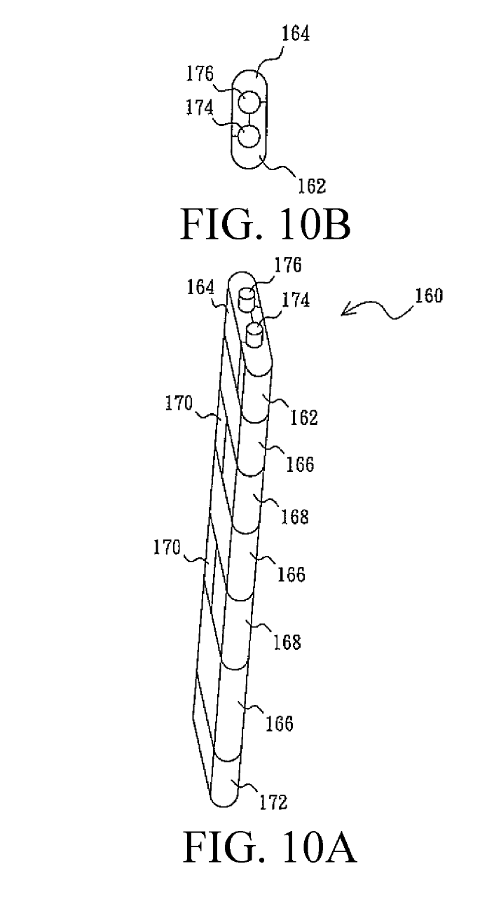

FIGS. 10A and 10B are respectively a three-dimensional view and a top view of a tableware practice tool kit according to a tenth embodiment of the present invention. In FIGS. 10A and 10B, the tableware practice tool kit 160 is formed by an upper right component 162, an upper left component 164, a plurality of middle components 166, a plurality of middle right components 168, a plurality of middle left components 170, a lower component 172, and two chopsticks 174 and 176.

The difference between the tenth embodiment and the first embodiment is that: in the tenth embodiment, the upper right component 162 and the upper left component 164 may be combined into an upper component; and the middle right components 168 and middle left components 170 may be combined into combined middle components. The upper component may be combined with the combined middle components or the middle components 166. The combined middle components may be combined with other combined middle components, the middle components 166 or lower component 172. The middle components 166 may be combined with the lower component 172. Through the arrangement and combination of the upper right component 162, upper left component 164, middle components 166, middle right components 168, middle left components 170, and lower component 172, a combined main body is formed. Then two chopsticks 174 and 176 are inserted into two spaces for accommodating chopsticks in the combined main body so as to form the tableware practice tool kit 160 according to the tenth embodiment.

For make the description concise, the same or similar structure and efficacy of the tenth and first embodiments are not elaborated herein.

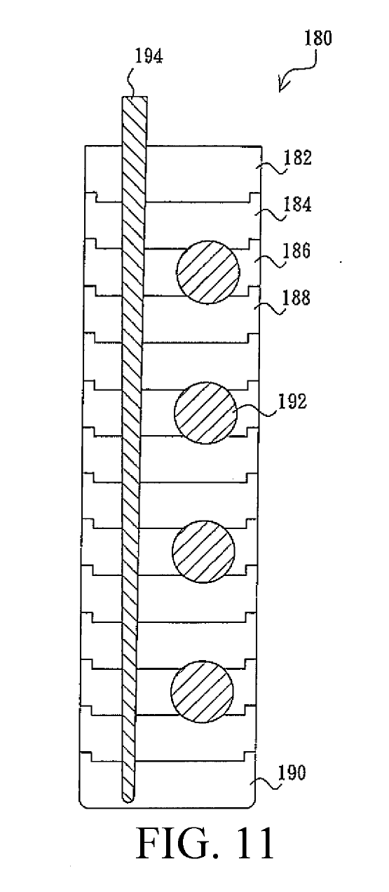

FIG. 11 is a cross-sectional view of a tableware practice tool kit according to an eleventh embodiment of the present invention. In FIG. 11, the tableware practice tool kit 180 is formed by an upper component 182, a plurality of first middle components 184, a plurality of second middle components 186, a plurality of third middle components 188, a lower component 190, a plurality of round balls 192, and a chopstick 194.

The difference between the eleventh embodiment and the first embodiment is that: in the eleventh embodiment, the plurality of first middle components 184, second middle components 186, and third middle components 188 form a plurality of groups of middle components. The first middle components 184, second middle components 186, and third middle components 188 are combined into the middle components in a way of stacking blocks, and spaces for accommodating the round balls 192 serving as the objects for practice are formed in the interior of the middle components.

In the eleventh embodiment, the upper component 182, first middle components 184, second middle components 186, third middle components 188, and lower component 190 are combined into a combined main body in a way of stacking blocks for practicing combining and disassembling. The upper component 182, first middle components 184, second middle components 186, third middle components 188, and lower component 190 can be used as objects for practice. In the combining process, the round balls 192 are placed in the spaces for accommodating the round balls 192 in the combined main body for practice, and the chopstick 194 is inserted into and taken out from the space for accommodating the chopstick 194 in the combined main body. When the combined main body is disassembled to take out the chopstick 194 and round balls 192, the chopstick 194 can be used to practice picking up the round balls 192, upper component 182, first middle components 184, second middle components 186, third middle components 188, lower component 190, and so on. In this way, the handle, direction, angle, and force of hands are trained.

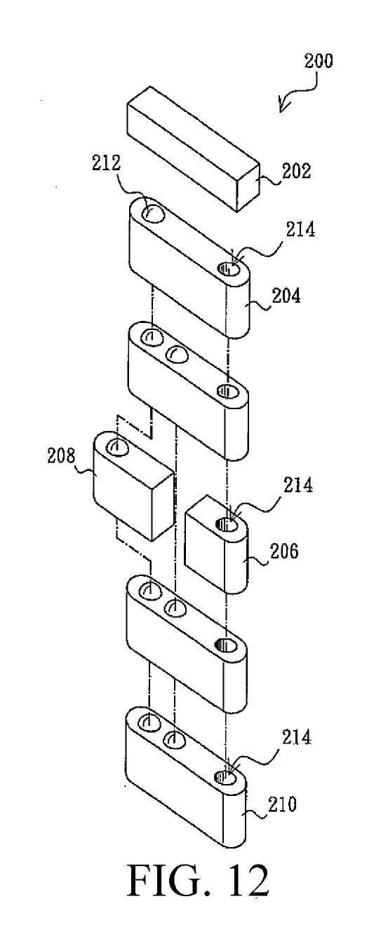

FIG. 12 is an exploded view of a tableware practice tool kit according to a twelfth embodiment of the present invention. In FIG. 12, the tableware practice tool kit 200 is formed by an upper component 202, a plurality of middle components 204, a middle right component 206, a middle left component 208, a lower component 210, and a plurality of round balls 212.

In the twelfth embodiment, the upper component 202, middle components 204, middle right components 206, middle left components 208, and lower component 210 having the shapes of geometric blocks are combined into a combined main body. Spaces for accommodating round balls 212 are formed in the middle components 204, middle left components 208, and lower component 210 respectively. Holes 214 are formed in the middle components 204, middle right components 206, and lower component 210 respectively to connect the components vertically. Thus, a space for accommodating the chopstick (not shown) is formed.

In the twelfth embodiment, the upper component 202, middle components 204, middle right components 206, middle left components 208, and lower component 210 are combined into a combined main body for practicing combining and disassembling. In the combining process, the round balls 212 are placed in the spaces for accommodating round balls 212 for practice, and the chopstick is inserted into and taken out from the space (that is, the holes 214) for accommodating the chopstick. When the combined main body is disassembled to take out the chopstick and round balls 212, the chopstick can be used to practice picking up the round balls 212. In this way, the handle, direction, angle, and force of hands of a child are trained.

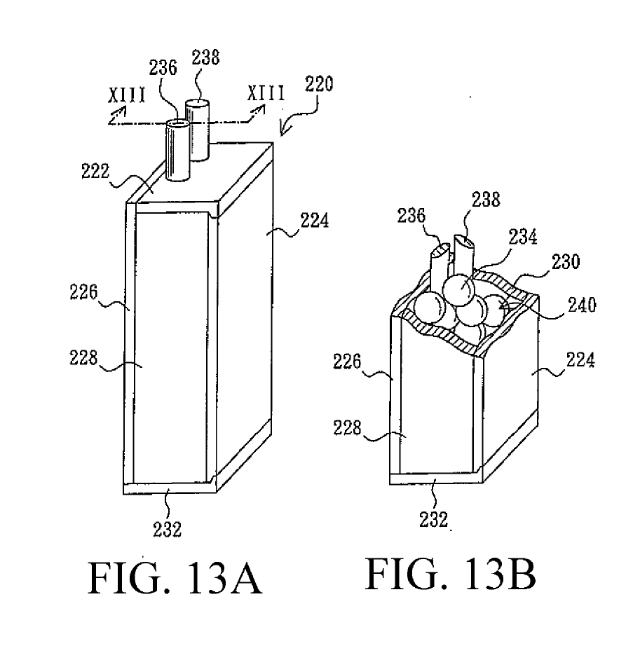

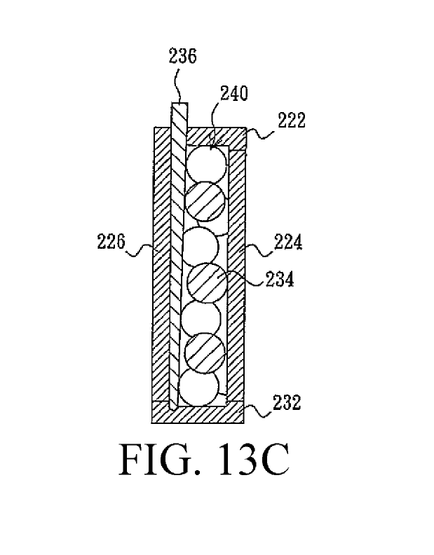

FIGS. 13A to 13C are respectively a three-dimensional view, a partial three-dimensional view, and a cross-sectional view of a tableware practice tool kit according to a thirteenth embodiment of the present invention. In FIGS. 13A to 13C, the tableware practice tool kit 220 is formed by an upper cover plate 222, a front side plate 224, a back side plate 226, a right side plate 228, a left side plate 230, a lower bottom plate 232, a plurality of round balls 234, and two chopsticks 236 and 238.

In the thirteenth embodiment, the upper cover plate 222, front side plate 224, back side plate 226, right side plate 228, left side plate 230, and lower bottom plate 232 having a sheet shape are combined into a combined main body. The round balls 234 are placed in a space 240 encircled by the upper cover plate 222, front side plate 224, back side plate 226, right side plate 228, left side plate 230, and lower bottom plate 232. The upper cover plate 222 has two holes, and the chopsticks 236 and 238 are respectively inserted into the two holes of the upper cover plate 222 so as to enter the space 240.

In the thirteenth embodiment, the upper cover plate 222, front side plate 224, back side plate 226, right side plate 228, left side plate 230, and the lower bottom plate 232 are combined into a combined main body for practicing combining and disassembling. In the combining process, the round balls 234 are placed in the space 240 for practice, and the chopsticks 236 and 238 are inserted into and taken out from the combined main body. When the combined main body is disassembled to take out the chopsticks 236 and 238 and round balls 234, the chopsticks 236 and 238 can be used to practice picking up the round balls 234. In this way, the handle, direction, angle, and force of hands are trained.

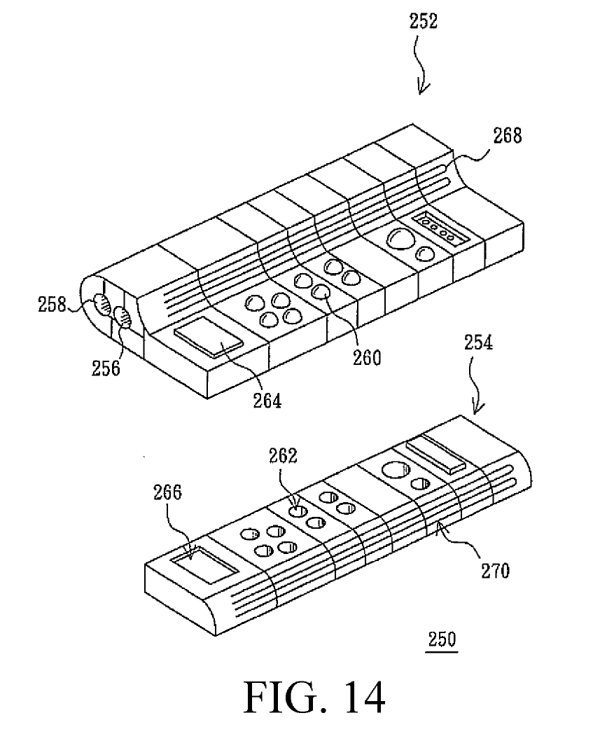

FIG. 14 is an exploded three-dimensional view of a tableware practice tool kit according to a fourteenth embodiment of the present invention. In FIG. 14, the tableware practice tool kit 250 includes a first combined main body 252 and a second combined main body 254. Components having different geometric shapes are combined into the first combined main body 252 and the second combined main body 254 in a way of stacking blocks similar to that in the first embodiment. The second combined main body 254 covers and is combined with the first main body 252. Spaces for accommodating the chopsticks 256 and 258 are formed in the first combined main body 252. Spaces 262 for accommodating round balls 260 having different sizes, a space 266 for accommodating a pancake 264, and a space 270 for accommodating noodle 268 are formed in the first combined main body 252 and the second combined main body 254 respectively. Here, the pancake 264 and noodle 268 are objects for practice instead of real food.

In the fourteenth embodiment, components having different geometric shapes are combined and assembled into the combined main bodies in a way of stacking blocks for practicing combing and disassembling. In the combing process, the round balls 260, pancake 264, and noodle 268 are respectively placed in the spaces 262, 266, and 270. The chopsticks 256 and 258 are inserted into and taken out from the combined main bodies. When the combined main bodies are disassembled to take out the chopsticks 256 and 258, round balls 260, pancake 264, and noodle 268, the chopsticks 256 and 258 can be used to practice picking up the round balls 260, pancake 264, and noodle 268. In this way, the handle, direction, angle, and force of hands are trained.

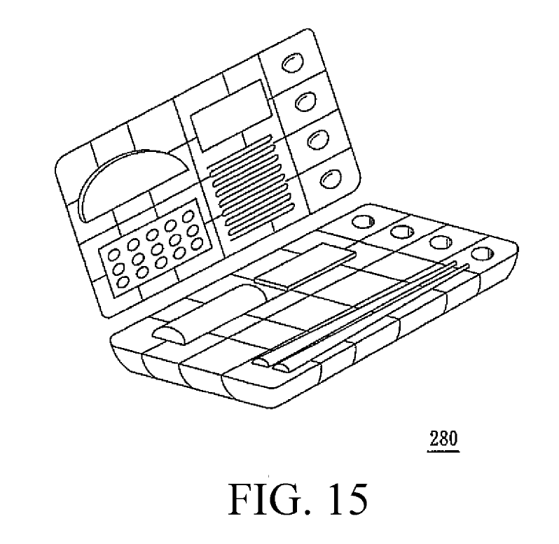

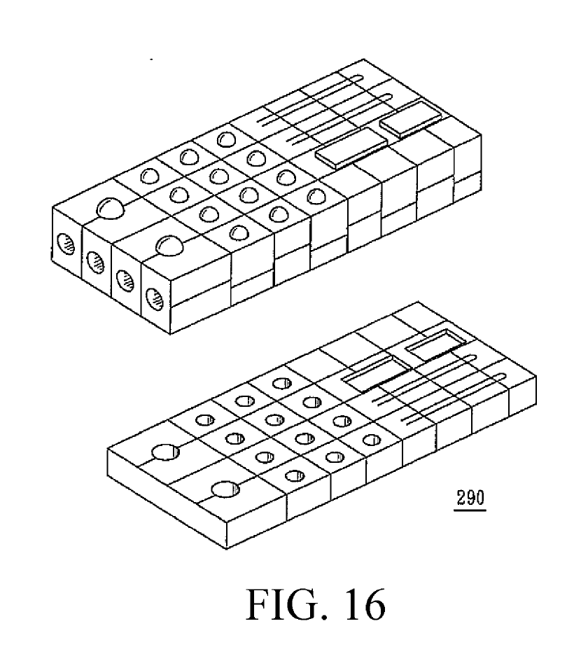

FIGS. 15 and 16 are respectively exploded three-dimensional views of tableware practice tool kits according to fifteenth and sixteenth embodiments of the present invention. The tableware practice tool kits 280 and 290 according to the fifteenth and sixteenth embodiments are the same as the tableware practice tool kit 250 according to the fourteenth embodiment, that is, components having different geometric shapes are combined and assembled into combined main bodies in a way of stacking blocks. The difference is that the shapes of the combined main bodies that have been combined and assembled of the tableware practice tool kits 280 and 290 in the fifteenth and sixteenth embodiments are different from those of the combined main bodies in the fourteenth embodiment. Therefore, the structures and efficacy of the tableware practice tool kits 280 and 290 according to the fifteenth and sixteenth embodiments are not elaborated herein.

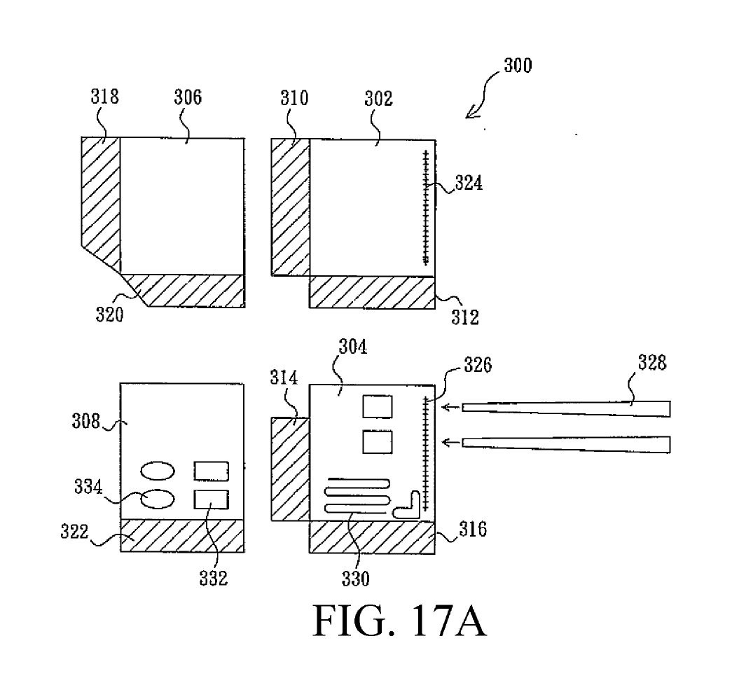

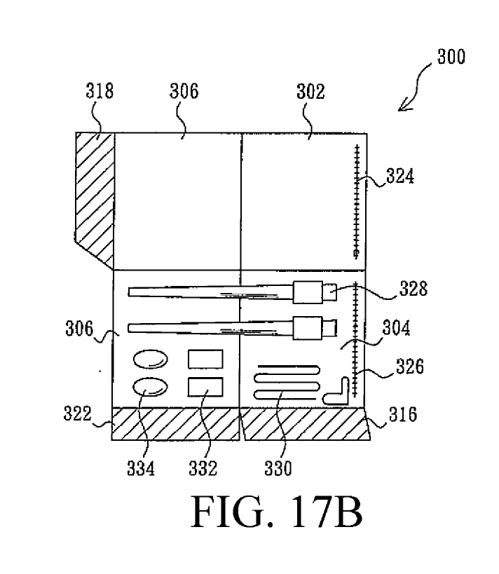

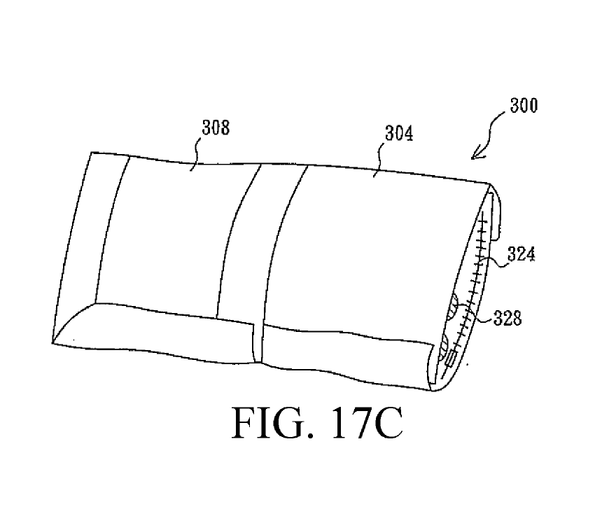

FIGS. 17A to 17C are respectively an exploded view and assembly views of a tableware practice tool kit according to a seventeenth embodiment of the present invention.

In FIGS. 17A to 17C, the tableware practice tool kit 300 is formed by a plurality of sheet components 302, 304, 306, and 308, chopsticks 328, noodle 380, pancakes 332, and elliptic balls 334. Velcro tapes 310 and 312 are disposed on side edges of the sheet component 302, velcro tapes 314 and 316 are disposed on side edges of the sheet component 304, velcro tapes 318 and 320 are disposed on side edges of the sheet component 306, and a velcro tape 322 is disposed on a side edge of the sheet component 308.

The velcro tapes 310 and 312 of the sheet component 302 respectively hook the sheet component 306 and sheet component 304, the velcro tapes 314 and 316 of the sheet component 304 respectively hook the sheet component 308 and sheet component 302, the velcro tapes 318 and 320 of the sheet component 306 respectively hook two sides of the sheet component 308, and the velcro tape 322 of the sheet component 308 hooks one side of the sheet component 306. The sheet components 302, 304, 306, 308 can be combined to form the tableware practice tool kit 300 shown in FIGS. 17B and 17C through the hooking of the velcro tapes 310, 312, 314, 316, 318, 320, and 322; in which spaces for accommodating the chopsticks 328, noodle 330, pancakes 322, and elliptic balls 334 shown in FIG. 17C are formed.

A side of the sheet components 302 and 304 respectively has a zipper 324 and 326. When the sheet components 302, 304, 306, and 308 are combined to form the tableware practice tool kit 300 shown in FIG. 17C, the zippers 324 and 326 can be closed so as to form a closed space in the tableware practice tool kit 300 shown in FIG. 17C.

In the seventeenth embodiment, the chopsticks 328, noodle 330, pancakes 322, and elliptic balls 334 are taken out from the tableware practice tool kit 300, and the chopsticks 328 are used to practice picking up the noodle 330, pancakes 322, elliptic balls 334, and so on. In this way, the handle, direction, angle, and force of hands are trained.

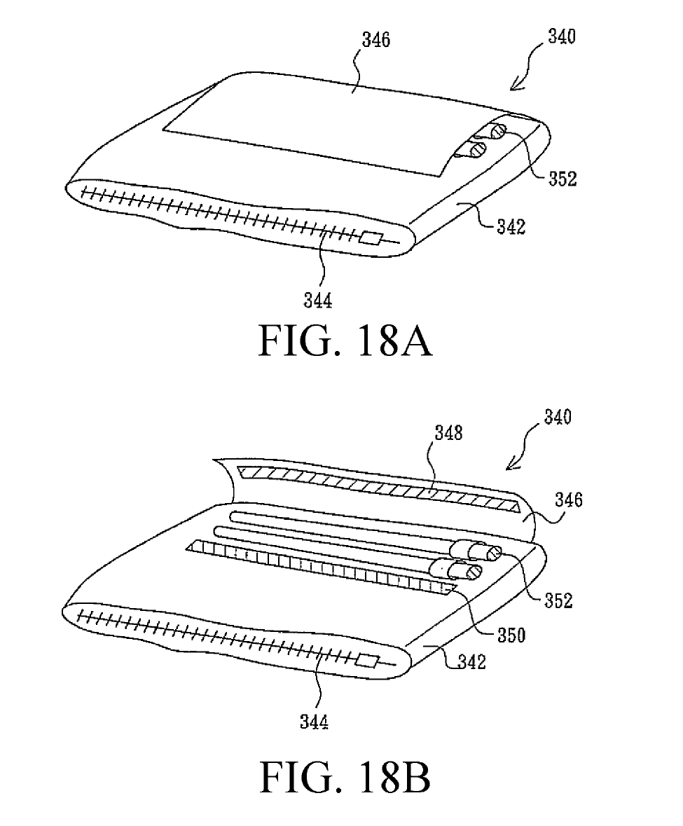

FIGS. 18A and 18B are respectively three-dimensional views of a tableware practice tool kit according to an eighteenth embodiment of the present invention. In FIGS. 18A and 18B, the tableware practice tool kit 340 is formed by a bag main body 342 and chopsticks 352. The outside surface of the bag main body has a covering part 346 and a velcro tape 350. A side edge of the covering part 346 has a velcro tape 348.

When the covering part 346 covers the outside surface of the bag main body 342, the velcro tape 348 of the covering part 346 is made to hook the velcro tape 350 of the bag main body so as to form spaces for accommodating the chopsticks 352. A side edge of the bag main body 342 has a zipper 344. When the zipper 344 is unzipped or closed, the internal space of the bag main body 342 may be opened or closed. The internal space of the bag main body 342 can accommodate objects for practice.

In the eighteenth embodiment, the chopsticks 352 are taken out from the space formed by the outside surface of the bag main body 342 and the covering part 346, and the objects for practice are taken out from the internal space of the bag main body 342. The chopsticks 352 are used to practice picking up the objects for practice. In this way, the handle, direction, angle, and force of hands are trained.

According to the above embodiments, an advantage of the present invention is to provide a tableware practice tool kit, which provides tableware and objects that are similar to shapes of different kinds of food and is convenient to carry. Therefore, the practice is not limited by the time and environment, and a person can practice using the tableware at any time in a game manner so that the person can use the tableware well rapidly.

Although the present invention is described above with reference to preferred embodiments and exemplary drawings, the embodiments should not be regarded as a limitation of the present invention. Any modifications, omissions and variations on the content of the forms and implementations made by persons skilled in the art shall fall within the scope defined by the claims of the present invention.

What is claimed is:

1. A tableware practice tool kit, comprising:
a combined main body, formed by combining a plurality of components in an assembling way and/or in a way of stacking blocks, and forming a space for accommodating tableware.

2. The tableware practice tool kit according to claim 1, wherein the tableware is one of or a combination of chopsticks, a spoon, a knife, and a fork.

3. The tableware practice tool kit according to claim 2, wherein the material of the tableware is one of glass, wood, paper, plastic, rubber, foam, metal, soil and clay, or a composite material thereof.

4. The tableware practice tool kit according to claim 1, wherein the material of the combined main body is one of cloth, glass, wood, paper, plastic, rubber, foam, metal, soil, and clay, or a composite material thereof.

5. The tableware practice tool kit according to claim 4, wherein the cloth combined main body is hooked and combined by using velcro tapes.

6. The tableware practice tool kit according to claim 4, wherein the cloth combined main body has a zipper for closing.

7. The tableware practice tool kit according to claim 1, further comprising objects for practice, accommodated in the combined main body, and having a shape of one of a bean, a round ball, a pancake, and noodle or having shapes of a combination thereof.

8. The tableware practice tool kit according to claim 7, wherein the material of the objects for practice is one of cloth, glass, wood, paper, plastic, rubber, foam, metal, soil, and clay, or a composite material thereof.

9. The tableware practice tool kit according to claim 1, wherein the combined main body is disassembled into the components serving as the objects for practice.

10. A tableware practice tool kit, comprising:
a bag main body, having an internal storage space; and
a covering part, disposed on the outside surface of the bag main body;
wherein the covering part is covered over the outside surface of the bag main body so as to form a space for accommodating tableware.

11. The tableware practice tool kit according to claim 10, wherein the tableware is one of or a combination of chopsticks, a spoon, a knife, and a fork.

12. The tableware practice tool kit according to claim 11, wherein the material of the tableware is one of glass, wood, paper, plastic, rubber, foam, metal, soil, and clay, or a composite material thereof.

13. The tableware practice tool kit according to claim 10, wherein the material of the bag main body is one of cloth, paper, plastic, rubber, and, metal, or a composite material thereof.

14. The tableware practice tool kit according to claim 10, wherein the covering part is hooked on the outside surface of the bag main body by using velcro tapes.

15. The tableware practice tool kit according to claim 10, wherein the bag main body has a zipper for closing.

16. The tableware practice tool kit according to claim 10, further comprising objects for practice, accommodated in the space formed by the covering part and the outside surface of the bag main body; and having a shape of one of a bean, a round ball, a pancake, and noodle or having shapes of a combination thereof.

17. The tableware practice tool kit according to claim 16, wherein the material of the objects for practice is one of cloth, glass, wood, paper, plastic, rubber, foam, metal, soil and clay or a composite material thereof.
